(19) United States
(12) Patent Application Publication
(10) Pub. No.: US 2007/0175569 A1
(43) Pub. Date: Aug. 2, 2007

(54) ADHESIVE TAPE FOR AUTOMATIC REPLACEMENT OF ROLLS

(75) Inventors: MARKUS EIKMEIER, LENSAHN (DE); THOMAS GASSNER, HEIDGRABEN (DE); BERNHARD GEBBEKEN, HAMBURG (DE); CHRISTOPH NAGEL, HAMBURG (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, HAMBURG (DE)

(21) Appl. No.: 11/614,443

(22) Filed: Dec. 21, 2006

Related U.S. Application Data
(62) Division of application No. 10/490,124, filed on Sep. 23, 2004.

(51) Int. Cl. B31F 5/00; B32B 7/12

(52) U.S. Cl. 156/157; 428/354

(57) ABSTRACT

The invention concerns an adhesive tape for automatic replacement of rolls around which is wound a material in the form of a flat strip. Said adhesive tape comprises a main support and a self-adhesive substance on the front surface, and at least a fissile self-adhesive system on the rear surface. The invention is characterized in that the rear surface is further provided with a non-fissile self-adhesive system.

The invention relates to an adhesive tape for the flying splice of flat web material wound up into rolls, which is equipped with a main carrier, a self-adhesive composition on the front, and at least one adhesive cleavable system on the back, and to its use.

Flying splice in paper mills or the like is a common technique for replacing an old, almost fully unwound roll of paper by a new roll without having to stop the machines, which run at high speed. In order to ensure that the new roll of paper opens reliably in the splicing operation, for example, the topmost paper ply is perforated and so the paper web tears in predetermined fashion at the perforation.

More preferably, the end of the old paper web is bonded to the start of the new paper web in order to ensure maximum continuity of operation. A variety of forms of bonding and preparation is known, with different adhesive tape types and splice geometries. For instance, double-sided self-adhesive tapes, known as tabs, are used which on the one hand are of high tack but on the other hand, owing to their water-soluble self-adhesive compositions and paper carriers, do not cause disruption when the paper wastes are used again in the paper machine.

Conventionally the tabs are adhered manually to the start of the web: this operation requires the deployment of skilled personnel and leads to results which technically are not advantageous, since as a result of the sequence of paper webs and adhesive strips the bonds are relatively thick.

For adhesive bonding in flying splice a variety of products are available, including in particular those which in addition to a paper carrier have a water-soluble self-adhesive composition coated on either side.

Methods of preparing for and for implementing the splice and corresponding adhesive tapes are presented, for example, in the publications EP 418 527 A2, DE 40 33 900 A1, DE 196 28 317 A1, DE 196 32 689 A2 and DE 198 30 673 A1.

DE 196 28 317 A1 discloses an adhesive tape for applications of this kind with which, after splicing has taken place, there are no longer any adhesive areas; it achieves this by using a cleavable paper carrier which cleaves on splicing and, after the splicing has taken place, covers the adhesives. The nonadhesive covering of otherwise exposed adhesive regions is also disclosed by DE 196 32 689 A2. It describes an adhesive tape for dynamic loads during the splicing process, the paper carrier of which tape cleaves and, with its remnants, covers the adhesives.

DE 198 30 673 shows an adhesive tape for flying splice in paper converting machines or the like, which has a paper carrier coated on either side with a water-soluble self-adhesive composition. One marginal region of the back of the adhesive tape is equipped with a single-sided adhesive tape which, for its part, has a cleavable paper carrier.

A further variant is described in DE 198 30 674. There, an adhesive tape having two cleaving strips is illustrated.

DE 199 02 179 A1 also shows an adhesive tape for a splicing process. On its non-adhesive back, this adhesive tape carries a double-sided adhesive tape which has a cleavable paper carrier, which cleaves during the splicing process and covers the respective adhesives. In order to avoid instances of tearing during flying splice, the laminated-on adhesive tape is arranged recessed with a cleavable paper carrier, specifically at a certain distance from the long edge of the adhesive tape.

In actual practice, disadvantages are evident with the prior art adhesive tapes. A particular disadvantage with the adhesive tapes specified above is that they have to be bonded beneath the topmost paper web of a roll. This proves difficult in practice, and is particularly poorly suited to automated attachment with machine assistance, an applicator or the like. Bonding to a surface rather than behind it, then, is desirable.

In this context, the bonding of the adhesive tape for the preparation of the splice always takes place below the topmost ply of the new roll of paper. With this kind of bonding there continues to be a risk of creases forming in the topmost paper ply or of air inclusions beneath the topmost paper ply, which then lead to problems in the splicing operation.

DE 198 30 673 A1 does describe an adhesive tape for application to the topmost paper ply of a new roll of paper; this adhesive tape too, however, has distinct weaknesses owing to the construction of the product and the resultant complicated bonding, since for flawless functioning this adhesive tape has to be adjusted very precisely, and here again automated application is hindered. The adhesive tape described in DE 198 30 673 must be bonded flush with the leading paper edge of the new roll of paper, since otherwise the self-adhesive composition on the underside of the main carrier bonds the second paper ply as well, leading then to uncontrolled opening and hence to tearing.

It was an object of the invention, therefore, to provide an adhesive tape for the splicing operation that does not have the disadvantages of the prior art, or only to a reduced extent, and which is particularly suitable for automated application.

This object is achieved surprisingly, and unexpectedly for the skilled worker, by an adhesive tape as described in greater detail in the claims.

Claim 1 accordingly provides an adhesive tape for the flying splice of flat web material wound up into rolls, said tape being equipped with a main carrier, a self-adhesive composition on the front, at least one adhesive cleavable system, and at least one noncleaving self-adhesive system on the back.

Said noncleaving self-adhesive system is preferably in the form of a strip.

“Noncleaving” in this context refers to the function of this strip for the splice, as illustrated below. In this case, the noncleaving system should not cleave. Whether the system is capable in principle of cleaving in other applications, or not, is left open here.

The inventive adhesive tape is bonded by its noncleaving self-adhesive system on the underside to the topmost paper web in such a way that the paper edge finishes flush with the strip of the self-adhesive system or slightly overhangs it. The cleavable system is then bonded to the top side of the second paper ply of the new roll of paper. In this case the paper edge finishes flush with the noncleaving self-adhesive system or lies between it and the cleaving system. Thereafter the cover is removed from the self-adhesive composition of the top side, and the roll is prepared for the splice.

In one preferred embodiment the self-adhesive cleavable system and the strip of the noncleaving self-adhesive system on the back of the adhesive tape have a spacing L of at least 2 mm from one another, in particular at least 3 mm, very particularly at least 5 mm. As a result of the spacing L it is not necessary for the adhesive tape or the noncleaving system to be bonded precisely flush with the leading paper edge of the new roll of paper; instead, flawless functioning is ensured sufficiently if the leading paper edge lies in the region of the spacing L between the noncleaving system 10 and the cleaving system 6.

The cleavable system advantageously has a width (direction perpendicular to the longitudinal direction of the adhesive tape) of from 3 to 50 mm, in particular from 6 to 40 mm, very particularly from 6 to 15 mm.

In one preferred embodiment the cleavable system is recessed in the region of the leading edge (long edge 14) of the adhesive tape, so that the main carrier overhangs the cleavable system on the sides of the leading edge by a length E_{S} of advantageously up to 15 mm, in particular from 0.5 to 15 mm, preferably from 1 to 7 mm, and very preferably from 1.5 to 3.5 mm.

Irrespective of the application it is likewise possible with preference to employ a version of the inventive adhesive tape in which the cleavable system lies directly on the leading edge of the main carrier, i.e., is not recessed.

For certain applications, moreover, it may be of advantage if two or more self-adhesive cleavable strips are provided on the back of the carrier.

For the noncleaving self-adhesive system an outstanding possibility is to use a double-sided adhesive tape with or without carrier; alternatively it is likewise advantageous to apply a self-adhesive composition in a stripe.

The maximum width B_{N} (direction perpendicular to the longitudinal direction of the adhesive tape) of the noncleaving system is a product of the width B_{H} of the main carrier reduced by the width B_{S} of the cleaving system and the spacing L, reduced additionally whe appropriate by the recessed lengths E_{S} and E_{N}. Depending on application, E_{N}, B_{N}, B_{H}, B_{S} and E_{S} are optimized in relation to one another, in particular for the purpose of ensuring effective bonding via the self-adhesive composition 10 and effective functioning of the cleaving system 6.

The cleavable system is composed preferably of paper, film or a composite of papers, films or papers with films. It advantageously has a much lower cleavage resistance than a paper carrier, which is required to absorb tensile forces. The cleavable system or systems are based preferably on sized, highly consolidated paper, on a composite of paper and film or on a two-film composite, it being possible for the composite to be composed of films and/or papers joined linearly and/or pointwise in a defined fashion. Examples of papers, paper composite systems or films particularly suitable for this purpose include the following:
Readily cleavable paper systems
Duplex papers
   (papers laminated together in a defined manner; the cleaving operation is extremely homogeneous; no stress peaks are produced as a result, for example, of nonhomogeneous consolidation.
   These papers are used for producing wallpapers and filters.)
Highly consolidated papers sized together in a defined manner (papers having a high cleavage resistance).
   Sizing can be done, for example, with starch, starch-containing derivatives, wallpaper pastes based on methylcellulose (tesa® paste, tesa AG, Hamburg; Methylan®, Henkel KGaA, Dusseldorf) or else based on polyvinyl alcohol derivatives.
   Such systems are described, for example, in EP 0 757 657 A1.
Cleavable systems in which the cleavage forces are determined by the size of the bonding points; such systems are described, for example, in DE 198 41 609 A1.
Coextruded films.

In one very preferred embodiment of the invention the self-adhesive composition used (in the sense of the self-adhesive compositions corresponding to position numbers 3, 8, 9 and/or 10 in the figures) is an acrylate pressure-sensitive adhesive. It is possible advantageously to use both water-soluble and water-insoluble acrylates.

Additionally, natural and synthetic rubber compositions and dispersions of the above-described compounds can be employed. It is noted that it is possible in principle to use all basic types of pressure-sensitive adhesives which are suitable for such bonds.

High-shear-strength adhesives are of interest for use on the calender or on the dryer. For use in the paper industry or in normal newspaper printing, high-tack adhesives are employed at the present time.

Preference is given to using high-shear-strength self-adhesive compositions on the front: a particularly suitable pressure-sensitive adhesive is one whose shear strength is more than 1 000 minutes on coating base paper and more than 2 000 minutes on gravure paper, measured at 23° C. and 55% relative humidity under a load of 1 kg. High-shear strength pressure-sensitive adhesives allow the use of the correspondingly spliced flat webs in processes involving calenders or printing machines with drying installations.

For the noncleaving self-adhesive system 10 the adhesive used is with great preference one which has a higher shear strength than the adhesive 3. The adhesive 3 is preferably selected with a high tack.

The shear strength is measured as follows:

To measure the shear strength of adhesives they are coated onto a standard carrier (polyester films; thickness: 25 μm). Advantageously, a constant application rate of 25 g/m² is selected.

After the drying and optional crosslinking of the adhesive a strip 13 mm wide and at least 20 mm long is cut out and is adhered to a defined paper (e.g., gravure paper, e.g., Neopress T 54, 54 g/m², or coating base paper, e.g., Mediaprint, 135 g/m²). The bond area is 13 mm×20 mm. In order to ensure a constant pressure when bonding, the test specimen is overrolled slowly twice using a roller (weight: 2 kg). The test specimen produced in this way is loaded with a 1 kg weight parallel to the bond plane, and the time for which the adhesive strip remains on the paper is recorded.

In order to differentiate more effectively between the individual adhesives the test is carried out correspondingly at further test temperatures (e.g., 40° C. and 70° C.).

In order to ensure error-free functioning, the adhesive must hold a weight of 1 kg for more than 1 000 minutes on coating base paper and more than 2 000 minutes on gravure paper at 23° C. and 55% relative humidity.

Self-adhesive compositions of shear strength which can be used, particularly as self-adhesive composition 10, include, for example, acrylate self-adhesive compositions of the following constitution:
40 to 90% by weight acrylic acid, 60 to 10% butyl acrylate, or
40 to 90% by weight acrylic acid, 30 to 5% by weight butyl acrylate, 30 to 5% by weight ethylhexyl acrylate
Added plasticizer: ethoxylated alkylamines, preferably C16 to C18, more preferably having 15 to 25 ethoxy units.

The blend of plasticizer with polymer amounts to between 55 to 75% by weight plasticizer and 25 to 45% by weight polymer.

The polymerization takes place free-radically in polar solvents using ethanol as regulator. Partial crosslinking is accomplished with aluminum chelate (0.3 to 1.2% by weight, based on the total amount).

It is preferred to use a paper or film carrier of tensile strength as the main carrier. Examples of carrier materials that may be listed here include the following: low-crepe papers, machine-glazed base papers, glazed base papers coated on one side, consolidated, printable decorative papers coated on either side, wood-free, high-gloss kraft papers doubly coated on one side, without wishing to be restricted unnecessarily in the choice of carrier materials as a result of these examples.

In one advantageous embodiment the adhesive tape is provided with at least one means detectable by machine (without contact) by means of a detector, the detection being achieved preferably by metal, transponder systems or optical devices.

In the embodiments of the invention depicted here there is no need to use signal labels which are conventionally used to control the splicing operation.

In one preferred version the main carrier (2) is composed of a material to which at least one detectable additive is added, and/or the main carrier has at least one layer (X) of a detectable material.

In one embodiment of the inventive adhesive tape, for example, metal powders or granules are admixed to the actual carrier material, or the carrier's basic framework is provided with one or more metal layers. In a further variant of the inventive adhesive tape the integrated signal function is realized by providing the main carrier on its top and/or underside with an aluminum layer, advantageously over the whole area. As a layer, instead of aluminum, it is also possible to use any further materials which are detectable in accordance with the requirements, particularly metals, examples being copper, silver, and gold.

Layers of this kind may independently of one another be present on both the front and back of the adhesive tape and/or of the main carrier.

In another embodiment of the invention the detection is brought about by transponder systems, in particular by thin layer transponders, which are integrated into the adhesive tape. Embodiments with active and passive transponders can be realized here.

A further embodiment of the inventive adhesive tape features said adhesive tape being provided with devices which can be registered optically. These can be barcodes, for example, which can be read with a laser. If barcodes are used, it is possible, in addition to the actual detection effect, to transmit information, concerning for example the type or web thickness of the new roll. Thus if rolls of different type or quality are used, the processing system can be adjusted automatically to the new processing conditions without a need for further external control.

Optical reflectors or diffraction gratings which are fitted in or on the main carrier of the adhesive tape function in a similar way. These can likewise be detected optically and initiate the splicing operation.

A further example of optically detectable devices is specific colorations of the main carrier, which can likewise be registered by means of suitable detecting systems.

The invention further provides a splicing process in which the topmost paper web 11 of a roll is overstock with an adhesive tape 1, by the noncleaving system 10 present on the back of the adhesive tape being bonded to the web end of the topmost paper ply 11, while the double-sidedly adhesive cleavable system 6 on the back of the adhesive tape 1 itself bonds to the underlying, second paper web 12 and hence secures the topmost paper web 11; in this case, initially, any release material 4 present on the self-adhesive composition 3 has not been removed, so that the portion of the self-adhesive composition 3 that is required for the splicing process is still covered with release material 4 and the roll of paper, in this state, does not have any open adhesive area; subsequently, in final preparation for the splicing process, any release material 4 still present is removed, whereupon the new roll of paper thus equipped is placed alongside an old roll of paper which has almost fully unwound and is to be replaced, and is accelerated to the same rotational speed as said old roll, then pressed against the old paper web, the exposed self-adhesive composition of the adhesive tape bonding to the old paper web 13 with the paper webs at substantially the same speeds, while at the same time the cleavable system 6 cleaves and with its remnants nonadhesively covers both self-adhesive compositions 8 and 9 which were coated on it.

In one preferred version of the process the adhesive tape 1 is bonded at right angles to the running paper web or else at an acute angle of up to 30°, in particular up to 10°.

In a further advantageous version of the inventive process the adhesive tape 1 is applied automatically or semiautomatically to the roll of paper by means of an automatic device. The inventive adhesive tape 1 simplifies automated machine application to new rolls in preparation for the splicing operation.

The invention will be described in more detail below with reference to one example, though without wishing thereby to restrict it unnecessarily.

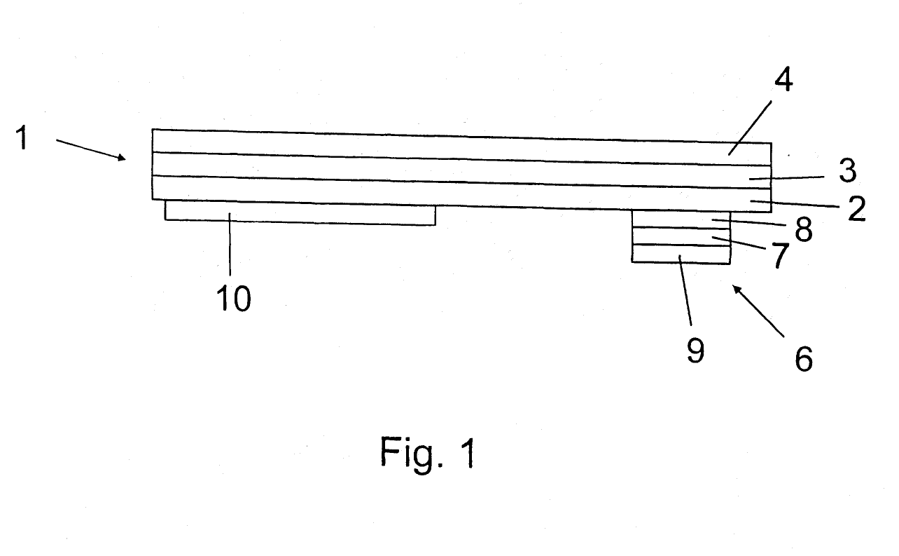

FIG. 1 shows a diagrammatic side view of an adhesive tape of the invention

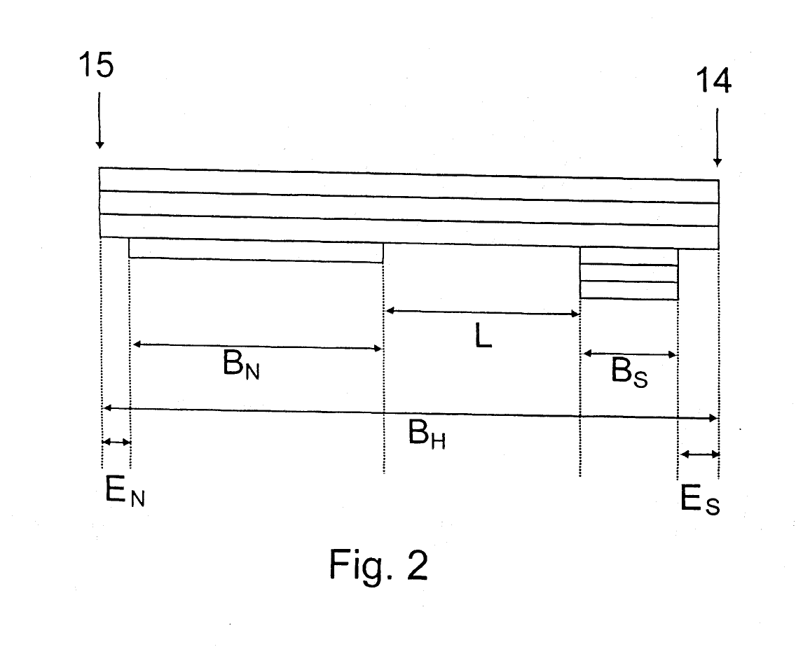

FIG. 2 shows a diagrammatic side view of an adhesive tape of the invention with a detectable device

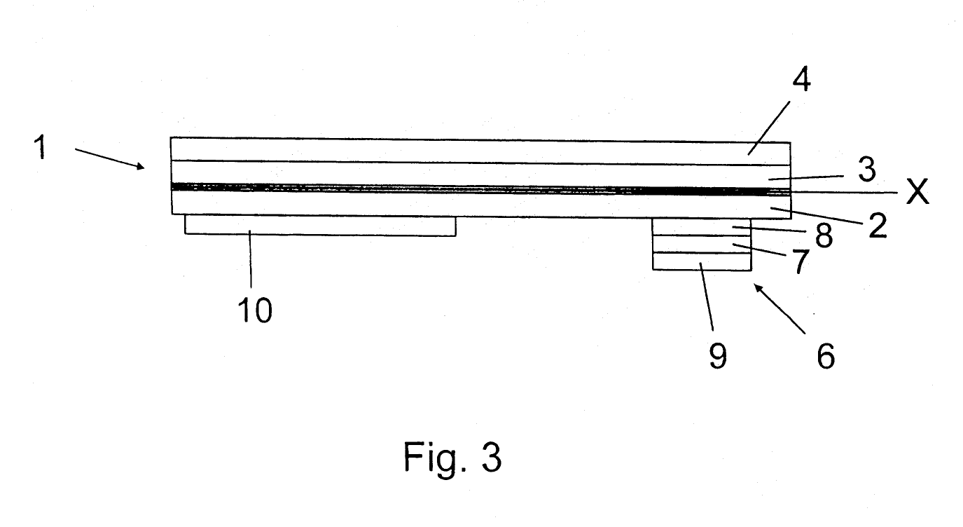

FIG. 3 shows a diagrammatic side view of the adhesive tape of FIG. 1, adhered to a roll of paper and ready for flying splice

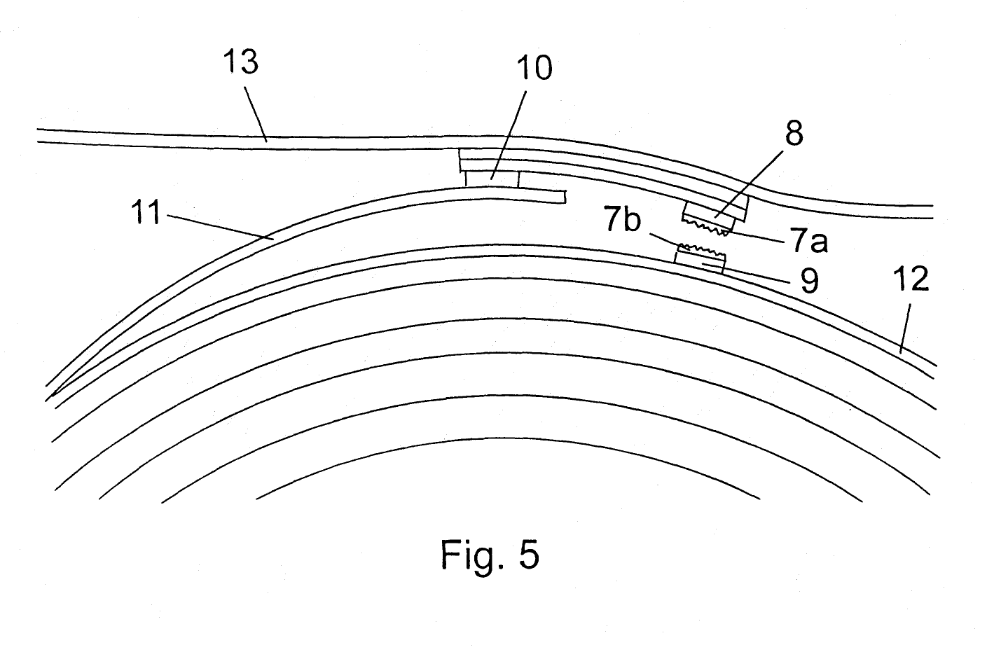

FIG. 4 shows a view in accordance with FIG. 2 but after flying splice has been completed

Specifically, FIG. 1 shows an adhesive tape 1 having a main carrier 2 of low-crepe kraft paper coated on one side with a water-soluble self-adhesive composition 3. The total thickness of the main carrier 2 with self-adhesive composition 3 is 0.115 mm, the width 75 mm. The self-adhesive composition 3 is covered with a siliconized release paper 4. Bonded beneath the right-hand end of the adhesive tape 1 is a strip of a double-sided adhesive tape 6 composed of a cleavable paper backing 7 coated on either side with water-soluble self-adhesive composition 8 and 9 respectively. The adhesive tape 6 has a width of 12 mm. At the left-hand end there is laminated a strip of a self-adhesive composition 10, which in this case likewise has a width of 12 mm.

FIG. 2 shows an adhesive tape 1 having a main carrier 2 coated on one side with a water-soluble self-adhesive composition 3, as in FIG. 1. In this case the main carrier 2 is composed of a composite of low-crepe kraft paper and aluminum. In the exemplary embodiment there is an aluminum layer X on the front of the main carrier 2 (between the main carrier 2 and the self-adhesive layer 3). The total thickness of the main carrier 2 with self-adhesive composition 3 is 0.115 mm, the width 75 mm.

FIG. 3 shows how an adhesive tape 1 of the invention is adhered to a (new) roll of paper, specifically by the left-hand portion 10 onto the end of the topmost paper ply 11 and by the right-hand portion 7 onto the top of the underlying (second) ply 12 of the roll of paper.

The release paper 4 can then be removed from the top of the adhesive tape 1, so that the roll of paper thus equipped is ready for a flying splice, the bond of the adhesive tape 1 running over the roll at a right angle. At this point in time the self-adhesive composition 3 is lying open and, for flying splice, constitutes the contact area with the outgoing web of the preceding roll. The contact area has a width of 75 mm and extends over the entire width of the roll of paper.

The (new) roll of paper thus equipped is brought alongside the (old) roll of paper which has nearly unwound and with which the new roll is to be spliced. The new roll of paper is accelerated to a rotational speed which is a near match with the speed of the outgoing web. When the two speeds have been sufficiently synchronized, the splice can be completed: by means of a contact shaft, the outgoing web is brought into contact with the periphery of the new roll and in accordance with FIG. 4 the self-adhesive composition 3 is bonded to the outgoing paper web 13 of the old roll.

In the moment after adhesive contact the cleavable paper carrier 7 cleaves such that one portion 7a remains on the adhesive tape 1, where it covers the self-adhesive composition 8, while the other portion 7b remains on the self-adhesive composition 9 which bonds to the paper web 12. Accordingly, both self-adhesive compositions 8 and 9 are neutralized to some extent, no longer bond, and hence also no longer interfere with the further operation in the paper converting machines. The new roll of paper is joined firmly to the outgoing web by the self-adhesive composition 3, which has been bonded to the topmost ply of the roll of paper.

1.-10. (canceled)

11. An adhesive tape for a flying splice of flat web material wound up into rolls, said adhesive tape comprising a main carrier having a front side and a back side, a self-adhesive composition on said front side, and at least one self-adhesive cleavable system and at least one non-cleaving self-adhesive system on said back side, wherein said at least one self-adhesive cleavable system cleaves when a flying splice of flat web material wound up into rolls is effected.

12. The adhesive tape according to claim 11, wherein at least one of said at least one self-adhesive cleavable system and at least one of said at least one non-cleaving self-adhesive system are spaced at least 2 mm apart.

13. The adhesive tape according to claim 11, wherein at least one of said at least one self-adhesive cleavable system and at least one of said at least one non-cleaving self-adhesive system are spaced at least 3 mm apart.

14. The adhesive tape according to claim 11, wherein at least one of said at least one self-adhesive cleavable system and at least one of said at least one non-cleaving self-adhesive system are spaced at least 5 mm apart.

15. The adhesive tape according to claim 11, wherein said non-cleaving self-adhesive system comprises a double-sided adhesive tape with a carrier.

16. The adhesive tape according to claim 11, wherein said non-cleaving self-adhesive system comprises a double-sided adhesive tape without a carrier.

17. The adhesive tape according to claim 11, wherein said non-cleaving self-adhesive system comprises a self-adhesive composition coated in a stripe.

18. The adhesive tape according to claim 11, wherein said self-adhesive cleavable system is comprised of one or more papers, one or more films, or a combination thereof.

19. The adhesive tape according to claim 11, wherein said self-adhesive composition exhibits a shear strength of more than 1000 minutes on coating base paper at 23° C. and 55% relative humidity under a load of 1 kg.

20. The adhesive tape according to claim 11, wherein said self-adhesive composition exhibits a shear strength of more than 2000 minutes on gravure paper at 23° C. and 55% relative humidity under a load of 1 kg.

21. The adhesive tape according to claim 11, comprising at least one machine-detectable means, which is machine-detectable by means of a detector.

22. A method for a flying splice of flat web material wound up into rolls, said method comprising:
a) providing said adhesive tape according to claim 11;
b) over-striking a topmost paper web of a new roll with said adhesive tape;
c) bonding said non-cleaving system to a web end of a topmost paper ply of said new roll,
d) bonding said cleavable system to an underlying, second paper web of said new roll;
e) placing a the new roll beside an old roll which is unwinding and is to be replaced;
f) accelerating said new roll to substantially said same rotational speed as said old roll; and
g) pressing said new roll against said old roll to effect the flying splice of the new roll to the unwinding old roll.

23. The method according to claim 22, wherein said adhesive tape is bonded at right angles to a running paper web.

24. The method according to claim 22, wherein said adhesive tape is bonded at an acute angle of up to 30°.

25. The method according to claim 22, wherein said adhesive tape is bonded at an acute angle of up to 10°.

26. The method according to claim 22, wherein said adhesive tape is applied to said new roll of paper automatically or semi-automatically by means of an automatic device.
